(19) United States
(12) Patent Application Publication
(10) Pub. No.: US 2010/0254225 A1
(43) Pub. Date: Oct. 7, 2010

(54) FAULT TOLERANT TIME SYNCHRONIZATION

(76) Inventors: Edmund O. Schweitzer, III, Pullman, WA (US); Kenneth J. Fodero, Pullman, WA (US); Veselin Skendzic, Pullman, WA (US); David E. Whitehead, Pullman, WA (US); Christopher Huntley, West Vancouver (CA)

Correspondence Address: Schweitzer Engineering Laboratories, Inc.;Richard Edge, 2350 NE HOPKINS COURT, PULLMAN, WA, 99163-5603, US

(21) Appl. No.: 12/753,698

(22) Filed: Apr. 2, 2010

Related U.S. Application Data
(60) Provisional application No. 61/166,343, filed on Apr. 3, 2009.

(51) Int. Cl. G04C 11/02

(52) U.S. Cl. 368/47

(57) ABSTRACT

Systems and methods for distributing accurate time information to geographically separated communications devices are disclosed. Additionally, the desired systems and methods may adjust local time signals to compensate for measured signal drifts relative to more accurate time signals. Moreover, a system may determine a best available time signal based on a weighted average of available time signals or select a best available time signal based on weighted characteristics of various time signals. A system may be further configured to transmit time information embedded in an overhead portion of a SONET frame, including transmission of a standard or common time.

### RELATED APPLICATIONS

The present application claims the benefit under 35 U.S.C. §119(e) of U.S. Provisional Patent Application No. 61/166,343 filed Apr. 3, 2009, titled “GEOGRAPHICALLY DISTRIBUTED FAULT TOLERANT TIME SYNCHRONIZATION,” which application is incorporated herein by reference in its entirety.

### TECHNICAL FIELD

This disclosure relates to distribution of time information between networked devices. Particularly, this disclosure relates to accurate time distribution in an electric power transmission or distribution system.

### BRIEF DESCRIPTION OF THE DRAWINGS

Non-limiting and non-exhaustive embodiments of the disclosure are described, including various embodiments of the disclosure with reference to the figures, in which:

FIG. 1 is a diagram of an electric power distribution system.

FIG. 2A illustrates a block diagram of a time distribution system.

FIG. 2B illustrates the time distribution system of FIG. 2A after an exemplary reconfiguration compensating for a broken connection.

FIG. 2C illustrates the time distribution system of FIG. 2B after losing communication with an external common time reference.

FIG. 3 illustrates a flow diagram of one embodiment of a method for determining a calculated time by using a weighted average of available time signals.

FIG. 4 is a flow diagram of one embodiment of a method for adjusting a local time signal during a holdover period to compensate for a calculated signal drift.

FIG. 5 illustrates a time distribution system across a wide area network (WAN), where a common time reference is generated using a global positioning system (GPS).

FIG. 6 is a time distribution system including communications IEDs configured to distribute a common time reference to various IEDs.

FIG. 7 is an embodiment of a communications IED configured to receive, distribute, and/or determine a common time reference.

FIG. 8 is a block diagram of a synchronized transport module (STM) frame with a common time reference incorporated into an overhead portion.

In the following description, numerous specific details are provided for a thorough understanding of the various embodiments disclosed herein. However, those skilled in the art will recognize that the systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

Electric power transmission and distribution systems may utilize accurate time information to perform various monitoring, protection, and communication tasks. In connection with certain applications, intelligent electronic devices (IEDs) and network communication devices may utilize time information accurate beyond the millisecond range. IEDs within a power system may be configured to perform metering, control, and protection functions that require a certain level of precision between one or more IEDs. For example, IEDs may be configured to calculate and communicate time-synchronized phasors (synchrophasors), which may require that the IEDs and network devices be synchronized to within nanoseconds of one other. Many protection, metering, control, and automation algorithms used in power systems may benefit from or require receipt of accurate time information.

Various systems may be used for distribution of accurate time information. According to various embodiments disclosed herein, a power system may include components connected using a synchronized optical network (SONET). In such embodiments, accurate time information may be distributed using a synchronous transport protocol and synchronous transport modules (STMs). According to one embodiment, a common time reference is transmitted within a frame of a SONET transmission. In another embodiment, a common time reference may be incorporated into a header or an overhead portion of a SONET STM frame.

IEDs, network devices, and other devices in a power system may include local oscillators or other time sources and may generate a local time signal. In some circumstances, however, external time signals may be more accurate and may therefore be preferred over local time signals. A power system may include a data communications network that transmits a common time reference to time dependent devices connected to the data communications network. The common time reference may be received or derived from an accurate external time signal.

According to various embodiments, various time dependent devices may be configured to rely on a best available time signal, when available, and may be configured to enter a holdover period when the best available time signal is unavailable. In some embodiments, a device may be configured to monitor the drift of a local time source with respect to an external time source and to retain information regarding the drift. During the holdover period, an IED or network device may rely on a local time signal.

In certain embodiments, when a connection to a best available time source is lost, a new best available time source may be selected from the remaining available time sources. The network may select a local time signal based on the available local time signal's specified holdover accuracies, maximum allowed frequency deviations, clock accuracies, measured time offsets, measured frequency offsets, and/or measured holdover accuracies. According to one embodiment, a local time signal may be selected as the best available time signal based on Allan Variance tables associated with the available local time signals. When an external time signal is unavailable, a local time signal may serve as the best available time signal.

According to one embodiment, a device may assign a weighting factor to each of a plurality of time signals based on each time signal's respective Allan Variance. The device may then determine a common time reference by calculating a weighted average of the available time signals. Thus, during a holdover period, a weighted average of the time signals may be used to calculate a best available time signal. A calculated best available time signal may then be used to determine the common time reference to be used by time dependent devices.

Reference throughout this specification to “one embodiment” or “an embodiment” indicates that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer readable storage medium), a method, and a product of a process.

The phrases “connected to,” “networked,” and “in communication with” refer to any form of interaction between two or more entities, including mechanical, electrical, magnetic, and electromagnetic interaction. Two components may be connected to each other even though they are not in direct physical contact with each other and even though there may be intermediary devices between the two components.

Some of the infrastructure that can be used with embodiments disclosed herein is already available, such as: general-purpose computers, computer programming tools and techniques, digital storage media, and optical networks. A computer may include a processor such as a microprocessor, microcontroller, logic circuitry, or the like. The processor may include a special purpose processing device such as an ASIC, PAL, PLA, PLD, Field Programmable Gate Array, or other customized or programmable device. The computer may also include a computer readable storage device such as non-volatile memory, static RAM, dynamic RAM, ROM, CD-ROM, disk, tape, magnetic, optical, flash memory, or other computer readable storage medium.

As used herein, the term IED may refer to any microprocessor-based device that monitors, controls, automates, and/or protects monitored equipment within the system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. IEDs may be connected to a network, and communication on the network may be facilitated by networking devices including, but not limited to, multiplexers, routers, hubs, gateways, firewalls, and switches. Furthermore, networking and communication devices may be incorporated in an IED or be in communication with an IED. The term IED may be used interchangeably to describe an individual IED or a system comprising multiple IEDs.

IEDs and network devices may be physically distinct devices, may be composite devices, or may be configured in a variety of ways to perform overlapping functions. IEDs and network devices may comprise multi-function hardware (e.g., processors, computer-readable storage media, communications interfaces, etc.) that can be utilized in order to perform a variety of tasks, including tasks typically associated with an IED and tasks typically associated with a network device. For example, a network device, such as a multiplexer, may also be configured to issue control instructions to a piece of monitored equipment. In another example, an IED may be configured to function as a firewall. The IED may use a network interface, a processor, and appropriate software instructions stored in a computer-readable storage medium in order to simultaneously function as a firewall and as an IED. In order to simplify the discussion, several embodiments disclosed herein are illustrated in connection with IEDs; however, one of skill in the art will recognize that the teachings of the present disclosure, including those teachings illustrated only in connection with IEDs, are also applicable to network devices.

Aspects of certain embodiments described herein may be implemented as software modules or components. As used herein, a software module or component may include any type of computer instruction or computer executable code located within a computer readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer readable storage medium, which together implement the described functionality of the module. Indeed, a module may comprise a single instruction or many instructions, and may be distributed over several different code segments, among different programs, and across several computer readable storage media. Some embodiments may be practiced in a distributed computing environment where tasks are performed by a remote processing device linked through a communications network. In a distributed computing environment, software modules may be located in local and/or remote computer readable storage media. In addition, data being tied or rendered together in a database record may be resident in the same computer readable storage medium, or across several computer readable storage media, and may be linked together in fields of a record in a database across a network.

The software modules described herein tangibly embody a program, functions, and/or instructions that are executable by computer(s) to perform tasks as described herein. Suitable software, as applicable, may be readily provided by those of skill in the pertinent art(s) using the teachings presented herein and programming languages and tools, such as XML, Java, Pascal, C++, C, database languages, APIs, SDKs, assembly, firmware, microcode, and/or other languages and tools.

A common time reference refers to a time signal or time source relied on by a plurality of devices, and which is presumed to be more accurate than a local time source. The determination of accuracy may be made based upon a variety of factors. A common time reference may allow for specific moments in time to be described and temporally compared to one another.

A time source is any device that is capable of tracking the passage of time. A variety of types of time sources are contemplated, including a voltage-controlled temperature compensated crystal oscillator (VCTCXO), a phase locked loop oscillator, a time locked loop oscillator, a rubidium oscillator, a cesium oscillator, a microelectromechanical device (MEM), and/or other device capable of tracking the passage of time.

A time signal is a representation of the time indicated by a time source. A time signal may be embodied as any form of communication for communicating time information. A wide variety of types of time signals are contemplated, including an Inter-Range Instrumentation Group (IRIG) protocol, a global positioning system (GPS), a radio broadcast such as a National Institute of Science and Technology (NIST) broadcast (e.g., radio stations WWV, WWVB, and WWVH), the IEEE 1588 protocol, a network time protocol (NTP) codified in RFC 1305, a simple network time protocol (SNTP) in RFC 2030, and/or another time transmission protocol or system.

A variance value refers to a measure of stability of a time source or oscillator. A variety of types of variance values are contemplated, including but not limited to an Allan Variance, a modified Allan Variance, a total variance, a moving Allan Variance, a Hadamard Variance, a modified Hadamard Variance, a Picinbono Variance, a Sigma-Z Variance, etc.

Furthermore, the described features, operations, or characteristics may be combined in any suitable manner in one or more embodiments. It will also be readily understood that the order of the steps or actions of the methods described in connection with the embodiments disclosed herein may be changed, as would be apparent to those skilled in the art. Thus, any order in the drawings or detailed description is for illustrative purposes only and is not meant to imply a required order, unless specified to require an order.

In the following description, numerous details are provided to give a thorough understanding of various embodiments. One skilled in the relevant art will recognize, however, that the embodiments disclosed herein can be practiced without one or more of the specific details, or with other methods, components, materials, etc. In other instances, well-known structures, materials, or operations are not shown or described in detail to avoid obscuring aspects of this disclosure.

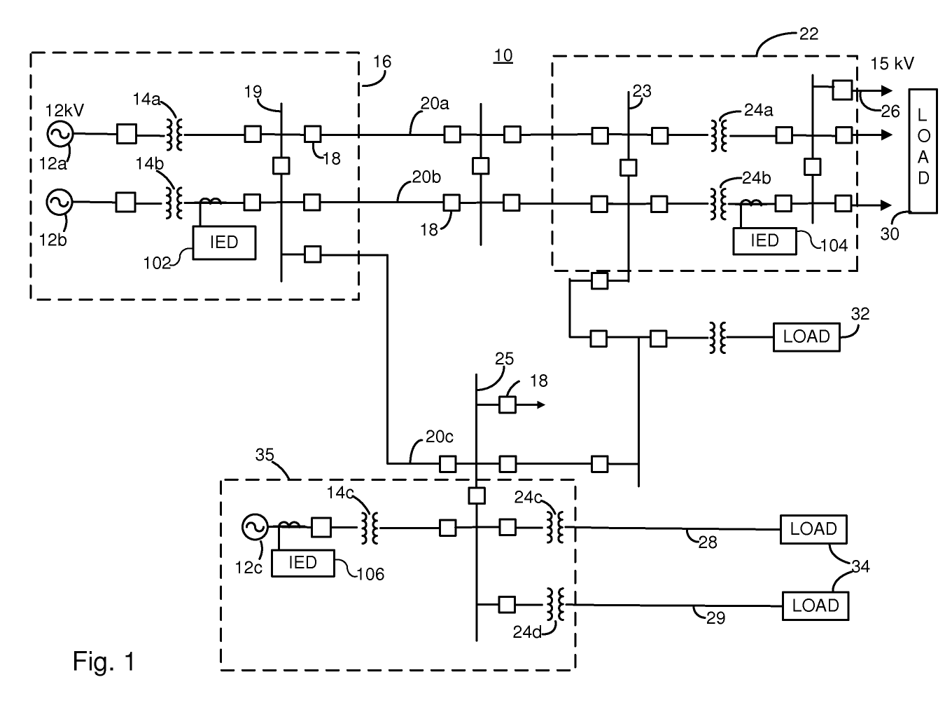

FIG. 1 illustrates a diagram of an electric power distribution system 10. The distribution system 10 includes intelligent electronic devices (IEDs) 102, 104, and 106 utilizing a common time reference to monitor, protect, and/or control system components. The electric power transmission and distribution system 10 illustrated in FIG. 1 includes three geographically separated substations 16, 22, and 35. Substations 16 and 35 include generators 12a, 12b, and 12c. The generators 12a, 12b, and 12c generate electric power at a relatively low voltage, such as 12 kV. The substations include step-up transformers 14a, 14b, and 14c to step up the voltage to a level appropriate for transmission. The substations include various breakers 18 and buses 19, 23, and 25 for proper transmission and distribution of the electric power. The electric power may be transmitted over long distances using various transmission lines 20a, 20b, and 20c.

Substations 22 and 35 include step-down transformers 24a, 24b, 24c, and 24d for stepping down the electric power to a level suitable for distribution to various loads 30, 32, and 34 using distribution lines 26, 28, and 29.

IEDs 102, 104, and 106 are illustrated in substations 16, 22, and 35 configured to protect, control, meter and/or automate certain power system equipment or devices. According to several embodiments, numerous IEDs are used in each substation; however, for clarity only a single IED at each substation is illustrated. IEDs 102, 104, and 106 may be configured to perform various time dependent tasks including, but not limited to, monitoring and/or protecting a transmission line, distribution line, and/or a generator. Other IEDs included in a substation may be configured as bus protection relays, distance relays, communications processors, automation controllers, transformer protection relays, and the like. As each IED or group of IEDs may be configured to communicate on a local area network (LAN) or wide area network (WAN), each IED or group of IEDs may be considered a node in a communications network.

As discussed above, an IED may be configured to calculate and communicate synchrophasors with other IEDs. To accurately compare synchrophasors obtained by geographically separate IEDs, each IED may need to be synchronized with a common time reference with accuracy greater than a millisecond to allow for time-aligned comparisons. According to various embodiments, time synchronization, accurate to the microsecond or nanosecond range, may allow IEDs to perform accurate comparisons of synchrophasors.

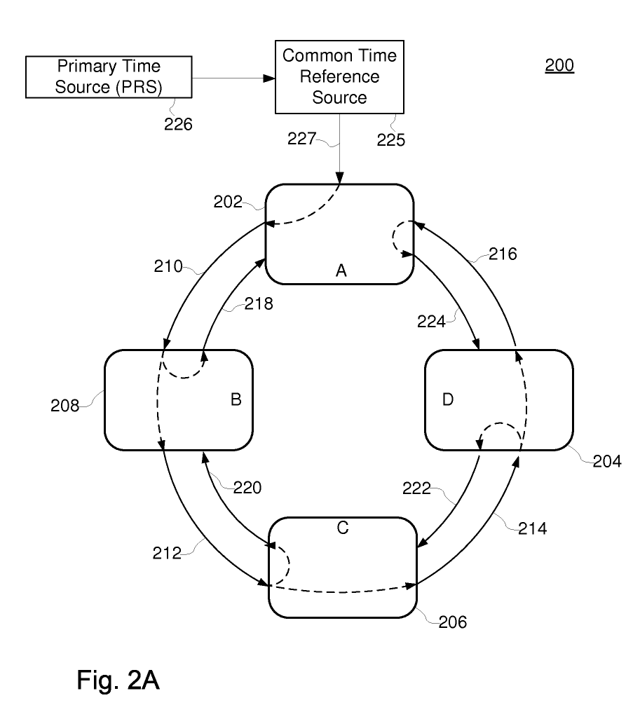

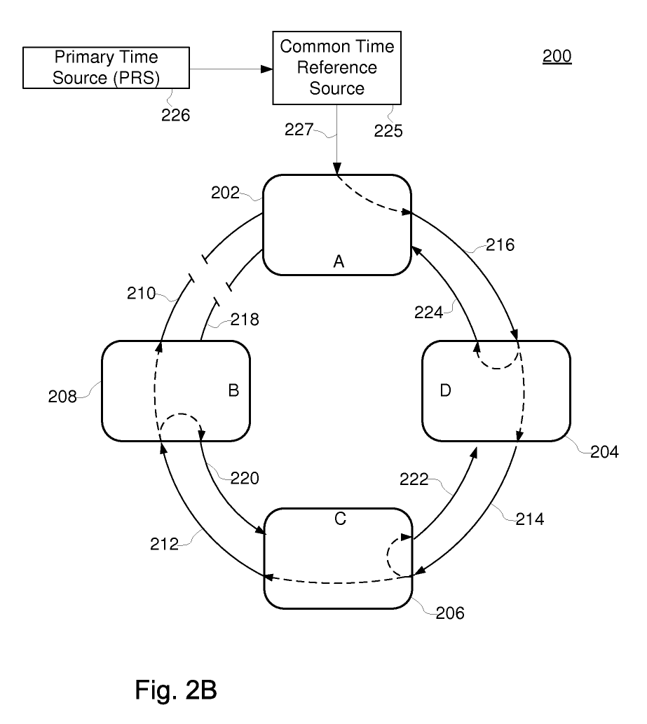

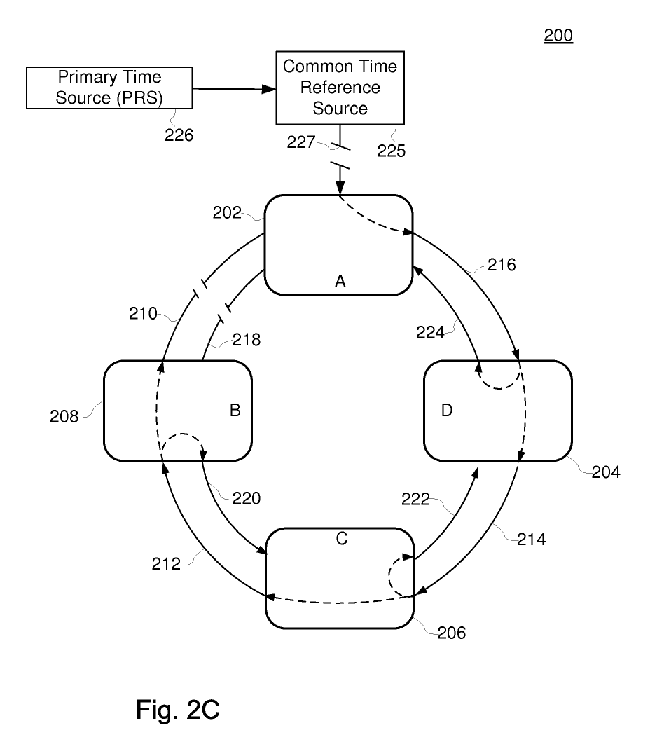

Various systems may be used for distribution of accurate time information. For example, a SONET system utilizing the synchronous transport protocol and STMs may be used in a power system to communicate time information among geographically separated IEDs. FIG. 2A illustrates a block diagram of a SONET system 200 including nodes 202, 204, 206, and 208. According to the illustrated embodiment, communications links 210-224 form a ring architecture. A primary time source (PRS) 226 is used to set a common time reference source 225, which provides a common time reference signal 227 to node 202. In certain embodiments, primary time source 226 and common time reference source 225 may be comprised within a single device. The common time reference is transmitted to node 208 via communications link 210 and through subsequent communications links 212 and 214 to nodes 206 and 204. Each node 202, 204, 206, and 208 may have a reverse communications link 218, 220, 222, and 224. According to various embodiments, the communications links may comprise fiber-optic communications links spanning large distances (e.g., 1 to 500 miles).

If one of the fiber communications links is damaged or unavailable, SONET system 200 may dynamically reconfigure itself as illustrated in FIG. 2B. As illustrated, with communications links 210 and 218 severed, node 202 transmits time synchronization information in the reverse directions. That is, time information is passed from node 202 to node 204, then to node 206, and finally to node 208. According to various embodiments, the timing information transmitted from node to node includes only time passage information. That is, SONET system 200 may provide a common frequency reference, which may allow each IED or device within node 202, 204, 206, and 208 to synchronize a local oscillator to the common time reference. According to an alternative embodiment, SONET system 200 transmits a common time reference. The common time reference allows each node 202, 204, 206, and 208, and IEDs within the nodes, to use the common time reference without reliance on a local time source.

If a set of nodes 202, 204, 206, and 208 loses communication with common time reference source 225, the isolated nodes may enter a holdover period. As is illustrated in FIG. 2C, the connection 227 between node 202 and common time reference source 225 is severed. Consequently, nodes 202, 204, 206, and 208 may enter a holdover period, during which time one of the nodes may be designated as a best available time source. A local time source of the designated node may then distribute time information based upon a local time source to other nodes in the network. During the holdover period, the best available time source may deviate gradually from the common time reference source 225; however, by maintaining a synchronized time among the connected nodes, time dependent information may still be produced and utilized. Consequently, during holdover periods when no common time reference source 225 is available, nodes that remain in communication may cooperate to maintain a common time.

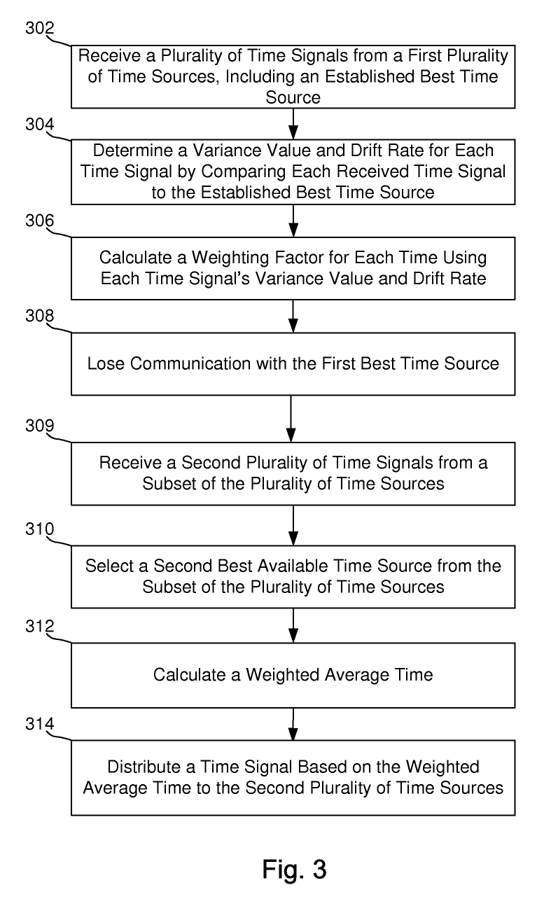

According to various embodiments, nodes remaining in communication during a holdover period may employ various systems and methods to compensate for signal drifts of local oscillators, calculate a weighted average time signal using an average of available time signals, and/or select a best available time signal. These techniques may allow for an isolated group of nodes to maintain a more accurate time signal during the holdover period. FIG. 3 illustrates one embodiment of a method for determining a “best available time source” when communication with an “established time best time source” has been lost, but where a plurality of time sources remain in communication.

When one or more nodes of a network become isolated or lose communication with the established time source, the nodes remaining in communication may determine the best available time source from among the available time sources, as illustrated in FIG. 3. According to the illustrated embodiment, a plurality of time signals are received from a plurality of time sources, including the established best time source 302. The system may then determine a variance value for each of the time signals by comparing each received time signal to the established best time source 304. A weighting factor for each time signal may be calculated by using each time signal's variance value 306. The weighting factor for each time signal may be calculated by dividing the minimum variance value (e.g., the variance value for the established best time source) by each time signal's respective variance value. Thus, the time signal with a variance value equal to the minimum variance value receives a weighting factor of 1, while a weighting factor of 0.5 is assigned to a time signal with a variance value twice as high as the minimum variance value. An exemplary equation for calculating a weighting factor, wₙ, for a given time signal at a given period n is shown below.

$${w}_{n} = \frac{min ( σ ( {τ}_{n} ) )}{σ ( {τ}_{n} )} \qquad Equation 1$$

In Equation 1, min (σ(τₙ)) is the minimum variance value (e.g., the variance value of the established best available time signal) at the given period n; and σ(τₙ) is the variance value of the given time signal at the given period n.

At 308, communication with the established time source is lost. The loss of communication may occur as a result of an equipment failure, damage to the communications network, or any number of other circumstances. Following the loss of communication with the first best time source 308, a subset of the plurality of time sources remains in communication. At 309, a second plurality of time signals from the subset of the plurality of time sources is received.

At 310, nodes remaining in communication with each other select a second best available time source. In one embodiment, the selection is based upon which time source has the minimum variance value. In alternative embodiments, other factors may also be taken into account when selecting a best available time source. Such characteristics may include stated holdover accuracies, frequency deviations, clock accuracies, offsets, and/or other information useful for determining a time source's quality.

At 312, a weighted average time is calculated. The weighted average time may be calculated using the time source of the second best available time source, the second plurality of time signals, and the respective calculated weighting factor of each of the second plurality of time signals. In this manner, more accurate time signals (i.e., those time signals having smaller variance values) are given greater weight in determining a common time reference than less accurate time signals (i.e., those time signals having larger variance values). At 314, a time signal based on the weighted average time is distributed to the plurality of time sources. The time signal based on the weighted average time may be distributed to the second plurality of time sources indefinitely, or until communication with the first best time source is restored.

According to various embodiments, the weighted average time may be adjusted periodically or continuously. In other words, the best available time source may routinely distribute a time signal based upon its own internal time source during a holdover period, and may only periodically calculate a weighted average time. In certain embodiments, only those time sources having a sufficiently large weighting factor may be utilized in calculating the weighted average time.

Alternatively, a weighted average time may also include a calculation of a drift rate of the best available time source relative to other available time signals. An equation for calculating a weighted average time, including a drift rate, is shown below.

$${T}_{corr} = \frac{1}{N} {\sum }_{n = 1}^{N} ( {T}_{n} - {T}_{0} ) {w}_{n} \qquad Equation 2$$

In Equation 2, T_{corr} is the time offset to be applied to the best available time source; N is the total number of available time signals, numbered 1 through N; Tₙ is a time received from a time signal n; T₀ is the time of the local time signal to be offset; and Wₙ is a weighting factor of a given Tₙ. By using an average of various time signals, the signal drift of any given time signal may be reduced. Accordingly, by adjusting the best available time source as described above, the accuracy of the best available time source may be increased.

Adjustments to the best available time source may be performed in small increments, thus allowing a distributed time signal to slowly approach a newly calculated weighted average time. According to one embodiment, changes are limited to increments of one microsecond per second. This approach is acceptable for small time differences (e.g., time differences below about 10 μs). If relatively large incremental adjustments are necessary, the distributed weighted average time signal may include a timing event notification, including the time of the correction, and the required time offset. Time correction events may be recorded for future use. The previously described methods for selecting, averaging, and adjusting time signals may be used alone or in conjunction with one another.

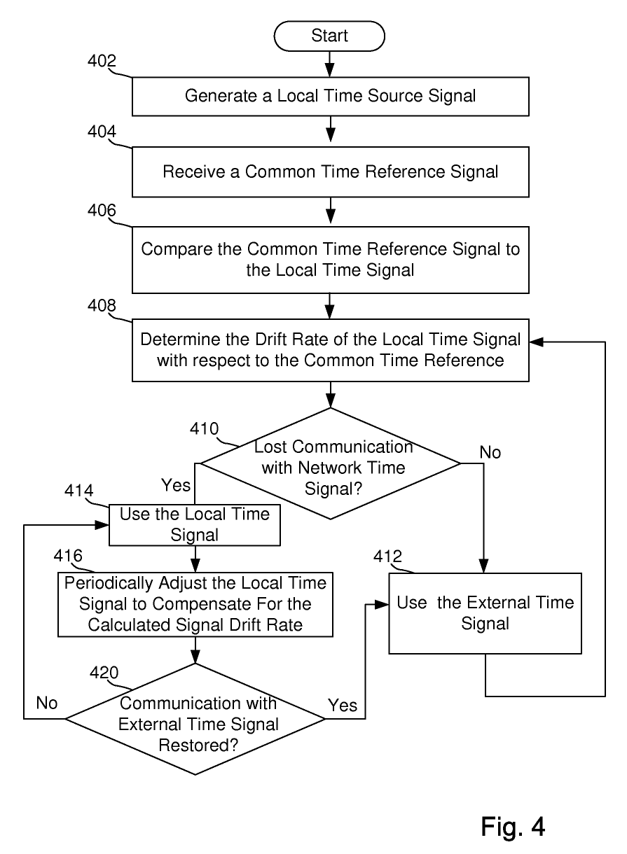

FIG. 4 illustrates a flow diagram of one embodiment of a method for adjusting a local time source during a holdover period to compensate for a calculated drift of the local time source. According to various embodiments, a device or group of devices may include a local time source and may generate a local time signal 402. The local time source may comprise a voltage-controlled temperature compensated crystal oscillator (VCTCXO), a phase locked loop oscillator, a time locked loop oscillator, a rubidium oscillator, a cesium oscillator, a microelectromechanical device (MEM), and/or other device capable to tracking the passage of time. As may be appreciated, it may not be economical to include in each device a local time source that is sufficiently accurate for performing certain functions, such as generating synchrophasors. Accordingly, a single accurate time source may generate a common time reference signal that is disseminated to a variety of connected devices.

According to various embodiments, a received common time reference signal provides, or can be used to derive, a more accurate time signal than a local time source 404. The external time signal may be received using an Inter-Range Instrumentation Group (IRIG) protocol, a global positioning system (GPS), a radio broadcast such as a National Institute of Science and Technology (NIST) broadcast (e.g., radio stations WWV, WWVB, and WWVH), the IEEE 1588 protocol, a network time protocol (NTP) codified in RFC 1305, a simple network time protocol (SNTP) in RFC 2030, and/or another time transmission protocol or system. NTP and SNTP precision is limited to the millisecond range, thus making it inappropriate for sub-millisecond time distribution applications. Both protocols lack security and are susceptible to malicious network attacks.

The IEEE 1588 standard includes hardware-assisted timestamps, which allows for time accuracy in the nanosecond range. Such precision may be sufficient for more demanding applications (e.g., the sampling of the sinusoidal currents and voltages on power lines to calculate “synchrophasors”). It is well suited for time distribution at the communication network periphery, or among individual devices within the network.

According to various embodiments, time signals may be communicated using a variety of physical communication systems and communications protocols. In one particular embodiment, SONET may be used. Furthermore, SONET frames may include an external time signal embedded in the header or overhead portion of each frame.

According to various embodiments, devices may utilize the common time reference signal in place of local time signals, when the external common time reference signal is available. The system may be configured to compare the external common time reference signal to the local time signal 406. Using the difference between the external and the local time signals, the system is able to determine a signal drift rate, fluctuations, and/or variability of the local time signal 408. According to various embodiments, if communication with the external time signal is available 410, then the external time provided by or derived from the external time signal is used 412. However, if communication with the external time signal is lost 410, a holdover period is entered during which the local time signal may be used 414.

As previously discussed, the local time source may not be as accurate as the external time source. To improve the accuracy during the holdover period, a system may periodically adjust the local time signal to compensate for the calculated signal drift 416. So long as communication with the external time signal is unavailable 420, the system will continue using the local time signal 414 with periodic adjustments for signal drift 416.

When communication with the external time signal is restored 420, the system may revert back to using the external time source 412. According to various embodiments, while an external time source is available, the signal drift is calculated in preparation for a loss of communication with the external time source. Consequently, the method described in FIG. 4 provides a method which may allow for the use of a less accurate local time source during a holdover period, but which has available information about its drift rate and/or other variance values that may be used to at least partially compensate for inaccuracies.

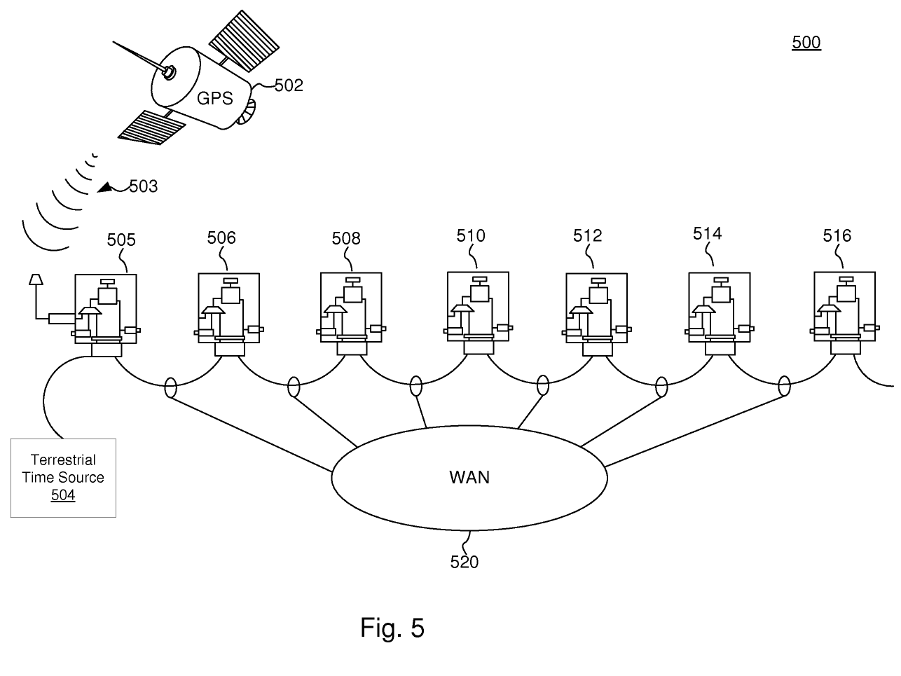

FIG. 5 illustrates a system 500 in which a common time reference signal 503 is generated by one or more GPS satellites 502. An IED 505 receives common time reference signal 503. IEDs 505, 506, 508, 510, 512, 514, and 516 (collectively IEDs 505-516) communicate via a LAN or a WAN 520. As illustrated, WAN 520 may comprise an Ethernet network, SONET, or other suitable networking system. IED 505 is configured to use common time reference signal 503 to establish a common time reference. The common time reference signal is communicated from IED 505 to IEDs 506-516. According to an alternative embodiment, common time reference signal 503 received by IED 505 is communicated to other IEDs 506-516, which are each configured to establish a unique, but equivalent, common time reference.

According to one embodiment, IEDs 505-516 may communicate a common reference time signal according to the IEEE 1588 standard, which may allow for the distribution of a time signal having accuracy on the order of nanoseconds. Consequently, so long as IED 505 receives common time reference signal 503, the networked IEDs 505-516 will maintain a common time reference.

If common time reference signal 503 becomes unavailable, IED 505 may rely on a local oscillator to establish a common time reference during the holdover period. To improve the accuracy of the common time reference during the holdover period, IED 505 may use previously calculated signal drift rates of its local time signal relative to the more accurate GPS time signal. IED 505 may periodically adjust the common time reference, or associated local time signal, to compensate for the measured signal drift. This allows the network of IEDs 505-516 to maintain a common time reference relative to one another. In various embodiments, IEDs 505-516 may also maintain a common time reference relative to devices outside of WAN 520.

Other embodiments may rely on terrestrial time source 504 as the primary or only source of the common time reference signal. Various environmental constraints (e.g., structural shielding, underground or underwater installation, and other factors), may make it impractical to rely on GPS as a common time reference. Furthermore, recent solar events and international community concerns about GPS ownership may make the use of GPS inappropriate for sensitive time distribution applications. Accordingly, in various embodiments, a terrestrial time source 504 may be utilized in addition to, or in place of, common time reference signal 503.

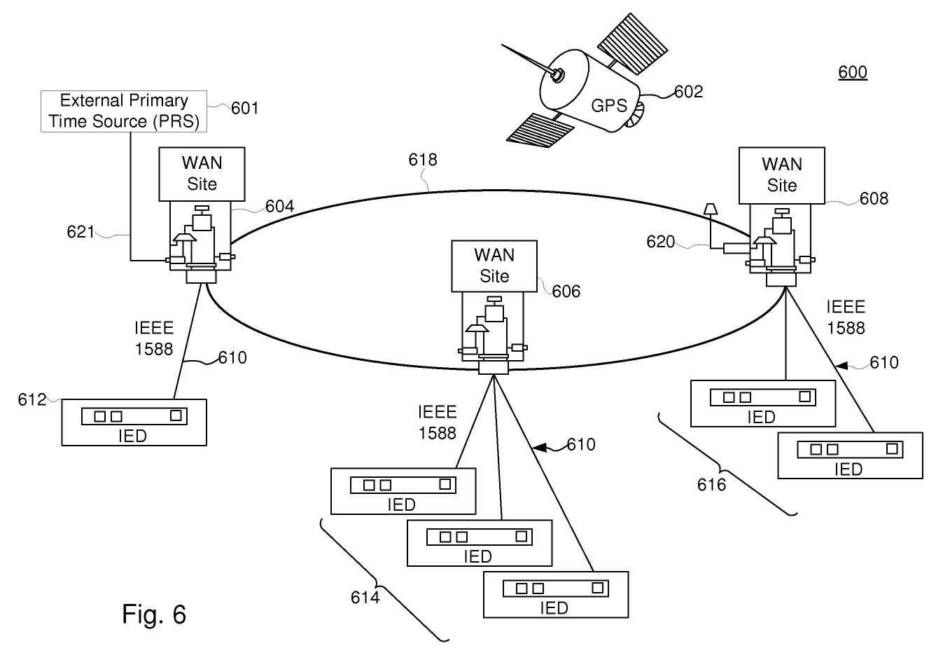

FIG. 6 illustrates a system 600 configured to utilize one or more of the methods described herein. FIG. 6 illustrates system 600 configured to be a highly reliable, redundant, and distributed system of time dependent IEDs 604, 606, and 608 capable of establishing or receiving a common time reference. Each IED 604, 606, and 608 may be configured to receive and communicate time signals through multiple protocols and methods. While the system 600 is described as being capable of performing numerous functions and methods, it should be understood that various systems are possible that may have additional or fewer capabilities. Specifically, a system 600 may function as desired using only one protocol, or having fewer external or local time signal inputs.

As illustrated in FIG. 6, three WAN sites 604, 606, and 608 are communicatively connected to a WAN 618, which may comprise one or more physical connections and protocols. Each WAN site 604, 606, and 608 may also be connected to one or more IEDs within a local network. WAN site 604 is connected to IED 612, WAN site 606 is connected to IEDs 614, and WAN site 608 is connected to IEDs 616. A WAN site may be, for example, a power generation facility, a distribution hub, a load center, or other location where one or more IEDs are found. In various embodiments, an IED may include a WAN port, and such an IED may be directly connected to WAN 618. IEDs may be connected via WAN 618 or LANs 610. WAN sites 604, 606, and 608 may establish and maintain a common time reference among various system components. Each WAN site 604, 606, and 608 may be configured to communicate time information with IEDs connected on its LAN through one or more time distribution protocols, such as IEEE 1588.

As illustrated, WAN site 604 receives a time signal 621 from an external primary time source (PRS) 601. External PRS may comprise one or more VCTCXOs, phase locked loop oscillators, time locked loop oscillators, rubidium oscillators, cesium oscillators, NIST broadcasts (e.g., WWV and WWVB), and/or other devices capable of generating accurate time signals. In the illustrated embodiment, WAN site 608 includes an antenna 620 configured to receive a GPS signal from a GPS repeater or satellite 602. As illustrated WAN site 606 does not directly receive an external time signal, however, according to alternative embodiments, any number and variety of external time signals may be available to any number of communications IEDs.

According to one embodiment, WAN 618 comprises a SONET configured to embed a common time reference in a header or overhead portion of a SONET frame during transmission. Alternatively, a common time reference may be conveyed using any number of time communications methods including IRIG protocols, NTP, SNTP, synchronous transport protocols (STP), and/or IEEE 1588 protocols. According to various embodiments, including transmission via SONET, a common time reference may be separated and protected from the rest of the WAN network traffic, thus creating a secure time distribution infrastructure. Protocols used for inter IED time synchronization may be proprietary, or based on a standard, such as IEEE 1588 Precision Time Protocol (PTP).

According to various embodiments, communications WAN sites 604, 606, and 608 are configured to perform at least one of the methods of time synchronization described herein. System 600 may utilize a single method or combination of methods, as have been described herein. As an example, system 600 may compare various characteristics of external time signals 601 and 602 to determine which of the two time signals is the best available time source for the application-specific tasks of system 600. After determining which of the two external time signals 601 or 602 is best, a common time reference is distributed throughout all network devices based on the selected time source. Alternatively, a common time reference may be a weighted average of the two external sources 601 and 602 or a weighted average of all time signals, including both external and local time signals. So long as a common time reference is available, system 600 may rely on one or more of the common time references to continuously establish an accurate common time reference.

If system wide communication to both external time signals 601 and 602 is disrupted, system 600 may enter a holdover period until communication is restored. During the holdover period, system 600 may rely on a best available local time source to establish a common time reference. According to one embodiment, characteristics of each time signal are compared and a best available time signal is selected to establish a common time reference. Additionally, the selected time signal may be adjusted to compensate for a previously measured signal drift, or by a time offset calculated using the average offset of other available time signals.

As another option, a weighted average of available time signals may be used to calculate a common time reference. Details regarding each of the possible methods to accurately maintain a common time reference are provided in conjunction with FIGS. 3 and 4. Various combinations of the methods may be used to maintain an accurate common time reference during holdover. Finally, when communication with an external time signal 601 and/or 602 is restored, system 600 may adjust the common time reference as needed incrementally, as described herein.

According to one embodiment, the common time reference is the only trusted source of time for system 600 and devices within it. Unless explicitly configured, none of the external signals are trusted until their accuracy is verified. Once verified, external time signals may be allowed to control or contribute to the common time reference. Verification may be performed based on the following signal parameters, which may be individually maintained for each available time signal, as illustrated in Table 1:

TABLE 1

| Signal | Measurement unit |
|---|---|
| Type of signal: | Enumeration per IEEE 1588, 2008 |
| Health: | Healthy, Suspect |
| Operating mode: | Traceable, Holdover |
| Network Time Participation: | Active, Under evaluation |
| Length of time in the holdover: | xx μs |
| Specified holdover accuracy: | ±xx * 1e−15 |
| Max. allowed frequency deviation: | ±xx * 1e−15 |
| Signal accuracy: | ±xx ns |
| Measured time offset: | ±xx ns |
| Measured frequency offset: | ±xx * 1e−15 |
| Measured holdover accuracy: | Allan Variance table |

Furthermore, time signal verification may be performed by classifying the time signal, evaluating the specified accuracy, verifying stability, and measuring various accuracy characteristics, and comparing with specified accuracy characteristics. The time signal may then be used in system 600 as appropriate. That is, a verified time signal may potentially contribute to or control the common time reference, depending on the method chosen to determine the common time reference and the accuracy of the time signal.

It is of note that even the most accurate time signals may exhibit small discrepancies. For example, depending on the length and routing of the GPS antenna cable, various clocks may exhibit microsecond level time offsets. Some of these offsets may be compensated by the user entering compensation settings, or may need to be estimated by the time synchronization network. Estimation may be performed during long periods of “quiet” operation (i.e., periods with no faults), with the individual source results stored locally in a nonvolatile storage register.

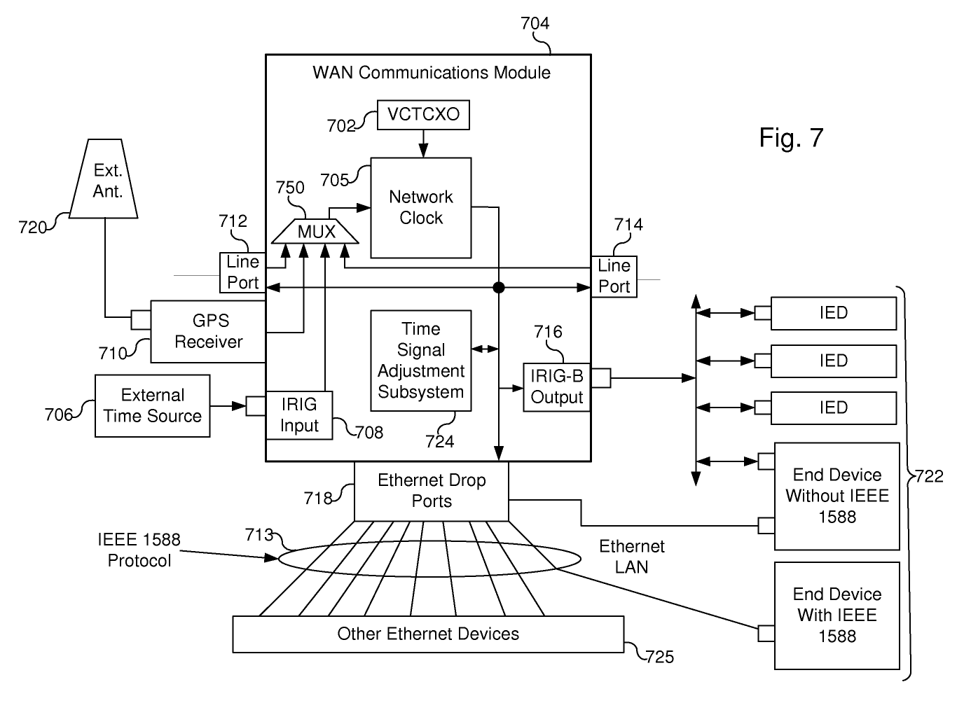

FIG. 7 illustrates a WAN communications module 704, according to one embodiment. A WAN communications module 704 may include more or less functionality than the illustration. For example, WAN communications module may include an interface for monitoring equipment in an electric power distribution system in certain embodiments. Accordingly, in various embodiments WAN communications module may be implemented either as an IED or as a network device. As illustrated, WAN communications module 704 includes a local time source 702 that provides a local time signal and a network clock 705 for establishing a common time reference. WAN Communications module 704 further includes a pair of line ports 712 and 714 for communications with a WAN or LAN. Time information may be shared over a network and may also be fed into the network clock 705. Further, WAN communications module 704 includes a GPS receiver 710 for receiving a common time reference signal, such as time from a GPS via a GPS antenna 720. GPS receiver 710 may be in communication with the GPS antenna 720. The received common time reference signal may also be communicated to the network clock 705.

Another time source that may be fed to the network clock 705 includes an external time source 706 that may conform to a time distribution protocol, such as IRIG. The external time source 706 may communicate with another time port such as an IRIG input 708.

The various time information from the WAN (from line ports 712 and/or 714), GPS receiver 710, and IRIG input 708 are first brought into a multiplexor (MUX) 750 before time information is brought into the network clock 705. The network clock 705 functions to determine a common time reference for use by the various devices connected to WAN communications module 704. Time information is then communicated from the network clock 705 to the various devices 722 using IRIG protocol (via the IRIG-B output 716) or to various devices 725 using another protocol 713 such as IEEE 1588 using Ethernet Drop Ports 718. The Ethernet Drop Ports 718 may also include network communications to the various devices connected to WAN communications module 704. WAN communications module 704 may further include connections to SONETs and transmit the common time reference in a header or overhead portion of SONET frames.

WAN communications module 704 may also comprise a time signal adjustment subsystem 724. Time signal adjustment subsystem 724 may be configured to track drift rates associated with various external time sources with respect to local time source 702. Time signal adjustment subsystem 724 may also generate a weighting factor for each of the plurality of time signals. Time signal adjustment subsystem 724 may also communicate time signals according to a variety of protocols. Such protocols may include inter-Range Instrumentation Group protocols, IEEE 1588, Network Time Protocol, Simple Network Time Protocol, synchronous transport protocol, and the like. In various embodiments, time signal adjustment subsystem 724 may be implemented using a processor in communication with a computer-readable storage medium containing machine executable instructions. In other embodiments, time signal adjustment subsystem 724 may be embodied as hardware, such as an application specific integrated circuit or a combination of hardware and software.

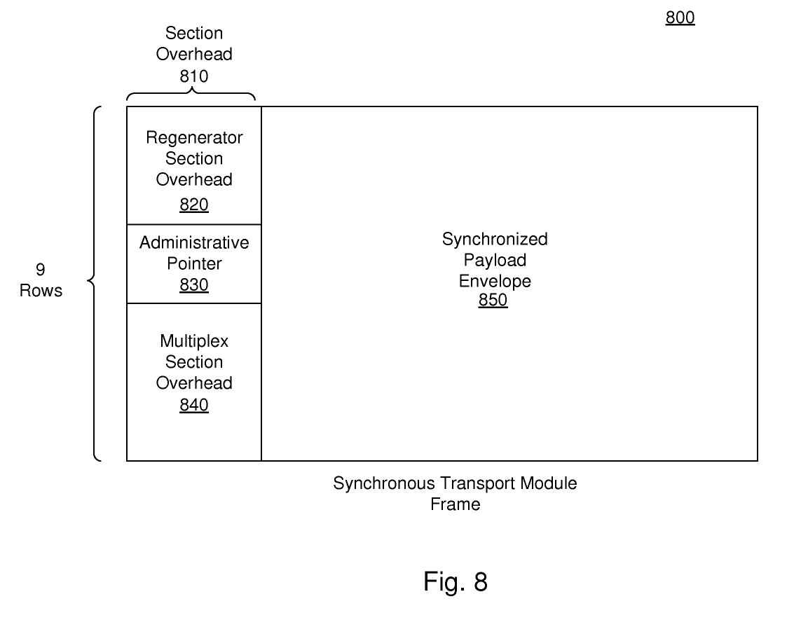

FIG. 8 is a block diagram of an STM frame 800 with a common time reference incorporated into a section overhead 810. According to various embodiments described herein, networked devices communicate with each other using a SONET transmitting STM frames. Various SONET STM frame formats and carriers may be used. The STM frame 800 in FIG. 8 represents a standard STM frame 800 having nine rows and the number of columns necessary to implement the chosen frame format. As illustrated, a frame comprises a section overhead 810 comprising a regenerator section overhead (RSOH) 820, an administrative pointer 830, and a multiplex section overhead (MSOH) 840. According to various embodiments, a common time reference may be embedded within one or more sections of the section overhead 810. Additionally, time information may also be included in the synchronized payload envelope 850.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed:

1. A method of time signal drift correction for an intelligent electronic device comprising:
a first Intelligent Electronic Device (IED) generating a first local time signal;
the first IED receiving an external time signal from an external time source;
the first IED calculating a first signal drift rate of the first local time signal relative to the external time signal;
upon losing reception of the external time signal, the first IED generating a first adjusted time signal based on the first local time signal and the calculated first signal drift rate; and
the first IED transmitting the first adjusted time signal to a second IED.

2. The method of claim 1, wherein the first local time signal is generated by at least one of a voltage-controlled temperature compensated crystal oscillator, a phase locked loop oscillator, a time locked loop oscillator, a rubidium oscillator, a cesium oscillator, and a microelectromechanical oscillator.

3. The method of claim 1, wherein receiving an external time signal comprises receiving a time signal from at least one of a global positioning system and a National Institute of Science and Technology radio broadcast.

4. The method of claim 1, wherein transmitting the first adjusted time signal to a second intelligent electronic device comprises transmitting the first adjusted time signal according to a protocol chosen from one of the group consisting of inter-Range Instrumentation Group protocols, IEEE 1588, Network Time Protocol, Simple Network Time Protocol, and synchronous transport protocol.

5. The method of claim 1, further comprising:
the second intelligent electronic device generating a second local time signal;
the second intelligent electronic device calculating a second signal drift rate of the second local time signal relative to the external time signal;
generating a second adjusted time signal to compensate for the calculated second signal drift rate;
receiving the first adjusted time; and
generating a second adjusted local time signal by averaging the first adjusted time signal and the second adjusted time signal.

6. The method of claim 1, further comprising transmitting the first adjusted time signal in an overhead portion of a synchronized optical network's synchronous transport frame.

7. The method of claim 1, wherein the IED comprises a network device.

8. A method of determining a weighted average time signal within an electric power distribution system, the method comprising:
a wide area network communications module in electrical communication with an electric power distribution system, the wide area network communications module receiving a plurality of time signals from a plurality of time sources;
the wide area network communications module calculating a variance value for each of the plurality of received time signals;
the wide area network communications module identifying a time signal from among the plurality of time signals having a minimum variance value;
the wide area network communications module calculating a weighting factor for each of the other plurality of time signals, each weighting factor based on the respective variance value and the minimum variance value; and
the wide area network communications module determining a weighted average time signal based on the identified time signal having the minimum variance value and based on a weighted value of each of the other plurality of time signals, the weighted value of each of the other plurality of time signals proportionate to the respective weighting factor of each of the other plurality of time signals;
the wide area network communications module distributing the weighted average time signal via a data communications network to a plurality of time dependent devices in electrical communication with the electric power distribution system.

9. The method of claim 8, wherein calculating a weighting factor for each of the plurality of time signals comprises dividing the minimum variance value by each time signal's respective variance value.

10. The method of claim 8, wherein receiving a time signal comprises receiving a time signal from at least one of the group consisting of: a voltage-controlled temperature compensated crystal oscillator, a phase locked loop oscillator, a time locked loop oscillator, a rubidium oscillator, a cesium oscillator, a microelectromechanical oscillator, a global positioning system, and a National Institute of Science and Technology radio broadcast.

11. The method of claim 8, wherein receiving a time signal comprises receiving a time signal according to a protocol comprising at least one of Inter-Range Instrumentation Group protocols, IEEE 1588 protocol, Network Time Protocol, Simple Network Time Protocol, and synchronous transport protocol.

12. An Intelligent Electronic Device (IED) configured to generate and distribute an adjusted time signal, comprising:
an external time input configured to receive an external time signal from an external time source;
a local time source configured to generate a local time signal;
a time signal adjustment subsystem configured to determine a signal drift rate of the local time signal relative to the external time signal, to adjust the local time signal to correspond to the external time signal when an external time signal is available, and to adjust the local time signal to compensate for the calculated average signal drift when an external time signal is unavailable; and
a time signal output configured to transmit the adjusted time signal to a second intelligent electronic device.

13. The IED of claim 12, wherein the time signal output comprises a fiber-optic transmitter.

14. The IED of claim 13, wherein the time signal output is configured to transmit the adjusted time signal using a synchronized optical network (SONET).

15. The IED of claim 14, wherein the time signal output is configured to transmit the adjusted time signal in a header portion of a synchronous transport module frame.

16. The IED of claim 12, wherein the time signal output is configured to transmit the adjusted time signal according to a protocol comprising at least one of Inter-Range Instrumentation Group protocols, IEEE 1588, Network Time Protocol, Simple Network Time Protocol, and synchronous transport protocol.

17. A method of determining and distributing a weighted average time signal in an electric power distribution system, the method comprising:
an Intelligent Electronic Device (IED) in electrical communication with an electric power distribution system, the IED receiving a first plurality of time signals from a first plurality of time sources;
the IED determining a first best available time signal from among the first plurality of time signals;
the IED calculating a weighting factor for each of the plurality of time sources;
upon losing communication with the first best available time signal, the IED receiving a second plurality of time signals from a second plurality of time sources, the second plurality of time signals comprising a subset of the first plurality of time signals;
the IED determining a second best available time signal from among the second plurality of time signals;
the IED determining a weighted average time signal based on the second best available time signal, the weighting factor associated with each of the second plurality of time signals, and the second plurality of time signals; and
the IED distributing the weighted average time signal to a plurality of time dependent devices in electrical communication with the electric power distribution system.

18. The method of claim 17, wherein determining a first best available time signal comprises a comparison of a characteristic of each of the first plurality of time signals, where the characteristic comprises at least one of a stated holdover accuracy, a frequency deviation, a clock accuracy, an offset, and an Allan Variance table.

19. The method of claim 17, wherein at least one of the first plurality of time sources comprises at least one of a voltage-controlled temperature compensated crystal oscillator, a phase locked loop oscillator, a time locked loop oscillator, a rubidium oscillator, a cesium oscillator, a microelectromechanical oscillator, a global positioning system, and a National Institute of Science and Technology radio broadcast.

20. The method of claim 17, further comprising:
the IED maintaining a signal drift rate of the second best available time signal maintaining relative to the first best available time signal prior to losing communication with the first best available time signal; and
wherein the weighted average time signal is further based on the signal drift rate.

21. The method of claim 20, further comprising transmitting the weighted average time signal in an overhead portion of a synchronized optical network frame in a synchronized optical network.
